(19) United States
(12) Patent Application Publication
(10) Pub. No.: US 2026/0352459 A1
(43) Pub. Date: Nov. 5, 2026

(54) Image-Driven Fulfillment Triggers and Visual Input Conversion to Platform-Controlled Execution

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,134

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. H04L 9/08; G06V 10/764; H04L 9/32

(52) U.S. Cl. CPC H04L 9/0894; G06V 10/764; H04L 9/3297; G06V 2201/07

(57) ABSTRACT

An image recognition system for sealed execution platforms that converts visual input into commercial fulfillment triggers. The system verifies origin, device metadata, and matches images to inventory objects. Execution is denied unless origin and license criteria are met. Escrow, jurisdiction, and trust scoring are applied before fulfillment is authorized.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates to image-based fulfillment in commercial environments and, more specifically, to image recognition systems that convert visual input into structured, platform-licensed transactions with sealed execution rails.

### BACKGROUND OF THE INVENTION

Traditional visual recognition systems can identify products or objects but are not bound to commercial execution protocols.

Existing models fail to tether image input to trusted, verified platform tools, allowing for unauthorized or rogue execution outside licensed rails.

There is a need for a sealed infrastructure where image input can initiate verified commercial activity only within a secure, licensed system.

### SUMMARY OF THE INVENTION

This invention introduces image-triggered commercial transactions governed by a sealed execution framework.

Images captured through licensed platform interfaces (apps, cameras, scanners) are converted into structured fulfillment requests.

The system blocks execution unless image origin, device license, and metadata are verified.

Each visual input is mapped to platform-native inventory or service objects and linked to escrow, jurisdiction, and licensing enforcement layers.

### BRIEF DESCRIPTION OF THE DRAWINGS

FIG. 1 Is a system diagram illustrating a visual recognition input module configured to receive image-based buyer requests through camera-enabled devices. Elements include [1601] visual input capture node, [1602] device-native image parser, [1603] platform-bound input router, and [1604] request object normalizer.

FIG. 2 Is a diagram illustrating the trust-verification layer applied to visual input triggers, enforcing execution only upon verified image authenticity and contextual alignment. Elements include [1605] image trust analysis unit, [1606] context validation engine, [1607] platform escrow initializer, and [1608] fulfillment authorization relay.

FIG. 3 Is a schematic diagram illustrating dynamic visual product recognition tied to verified seller inventories, wherein platform trust scores filter eligible fulfillers. Elements include visual product match engine, [1610] verified seller index, [1611] trust-weighted match logic, and [1612] escrow injection trigger.

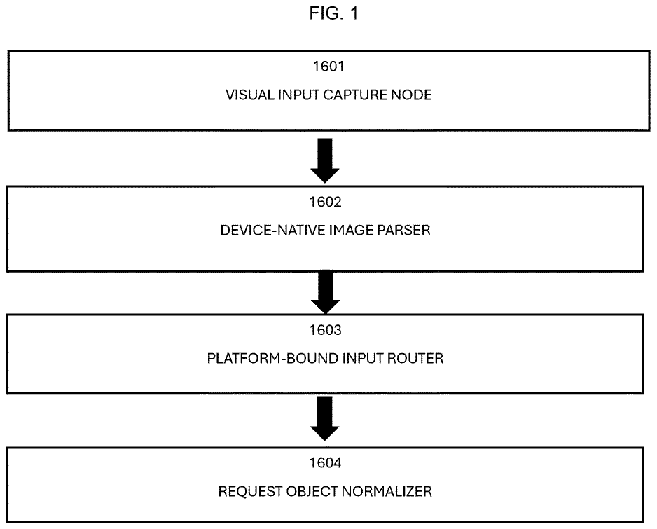

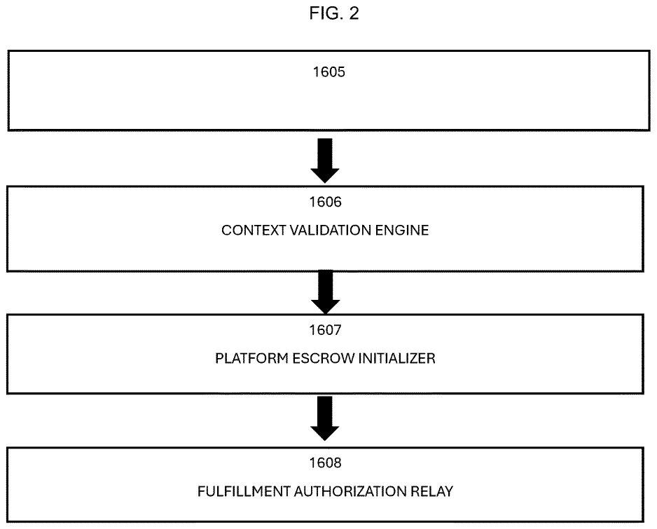

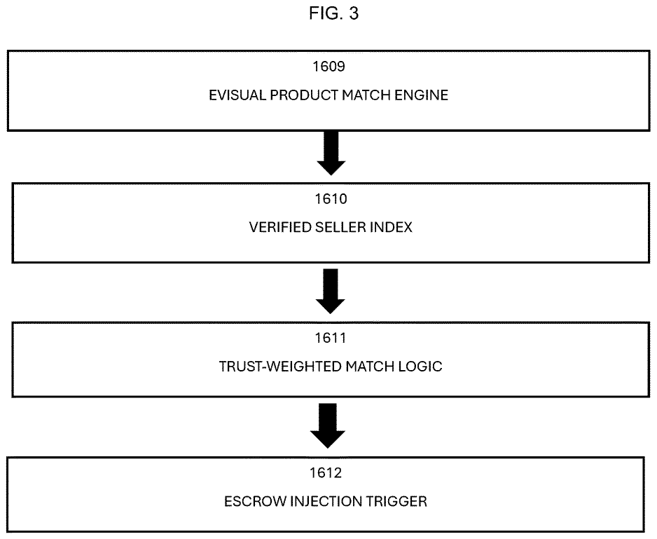

Each figure is uniquely identified by labels beginning at element 1601 and proceeding sequentially through element 1612, and each figure is distinct from those disclosed in FIGS. 1-12 of the master utility patent.

### DETAILED DESCRIPTION OF THE INVENTION

The system includes an image recognition module embedded in platform-native devices or interfaces.

Image origin is verified through device ID, app license, timestamp, and geolocation metadata.

Once verified, the image is analyzed using trained models to detect recognizable commercial objects.

Objects are matched to SKU or service identifiers within the platform's inventory or request databases.

Upon successful match, the system initiates structured fulfillment logic gated by escrow, jurisdiction, and license compliance.

Execution is denied if origin metadata, inventory match, or license chain fails validation.

The system may issue real-time feedback to the user including trust indicators, compliance notices, and vendor availability.

Transactions triggered by image input are logged and time-stamped for audit and platform-wide enforcement.

Visual input from unauthorized platforms is denied and flagged.

Edge-device modules may process image input locally but must sync results with platform servers before execution.

1. A system comprising: a licensed image input device; an origin verification engine; and a sealed execution module that initiates fulfillment only upon validation of origin, metadata, and inventory match.

2. The system of claim 1, wherein the origin verification engine checks device license, geolocation, timestamp, and session ID.

3. A method comprising: capturing an image through a platform-authorized tool; analyzing it for recognizable commercial objects; matching those objects to inventory; and gating execution through license and escrow checks.

4. The system of claim 1, wherein unauthorized input attempts are denied and logged.

5. The system of claim 1, wherein object detection is performed via trained visual classifiers.

6. The method of claim 3, further comprising jurisdictional filtering before offer presentation.

7. The system of claim 1, wherein metadata includes device signature, user account ID, session context, and software version.

8. A system wherein fulfillment is blocked if image origin does not match a platform-licensed interface.

9. The system of claim 1, wherein visual input modules are embedded in kiosks, phones, or smart appliances bound to platform ID.

10. The system of claim 1, wherein image-triggered requests include trust scoring and offer tiering based on metadata integrity.

11. A fulfillment control system comprising: image-to-inventory mapping logic, metadata scoring, and escrow-locked transaction routing.

12. The system of claim 11, wherein platform-only vendors are activated based on visual input trust score.

13. The method of claim 3, wherein denial triggers enforcement actions against unlicensed interfaces.

14. A commercial execution system comprising: a visual input reader, a license validator, an escrow module, and a metadata-based decision layer.

15. The system of claim 1, wherein fallback execution is offered through pre-cleared inventory tiers if trust score meets threshold.

16. The method of claim 3, wherein partial object detection results prompt user clarification before execution.

17. A sealed rail system for commercial transactions based on verified visual input and locked fulfillment paths.

18. The system of claim 1, wherein enforcement logs include denial reasons and platform enforcement flags.

19. The method of claim 3, further comprising alert notifications to platform admin upon unauthorized visual input attempts.

20. A visual commerce enforcement framework comprising: image capture, device validation, escrow enforcement, and structured offer issuance.

21. The system of claim 1, wherein the origin verification engine requires a platform-authenticated image source before tool activation is permitted.

22. The system of claim 14, wherein a recognition match must pass a multi-factor test including object presence, lighting compliance, and time-stamped capture validation.

23. The system of claim 15, wherein execution is deferred unless image metadata includes verified geo-coordinates within a permitted transaction zone.

24. The system of claim 1, wherein fulfillment by the sealed execution module is invalidated if the platform detects any prior use of the same image in a rejected session.
